(19) United States
(12) Patent Application Publication
(10) Pub. No.: US 2006/0206722 A1
(43) Pub. Date: Sep. 14, 2006

(54) Method and apparatus for networked biometric authentication

(76) Inventor: George Z.H. Zhang, San Mateo, CA (US)

Correspondence Address: Mr. George Z.H. Zhang, Apt. 204, 134 Elm Street, San Mateo, CA, 94401, US

(21) Appl. No.: 11/292,765

(22) Filed: Dec. 2, 2005

Related U.S. Application Data
(60) Provisional application No. 60/593,059, filed on Dec. 6, 2004.

(51) Int. Cl. H04K 1/00

(52) U.S. Cl. 713/186

(57) ABSTRACT

A system for using biometric data such as a fingerprint, eye imagery, or the like to permit previously identified persons with his or her biometric data in a database to gain access to a secured site from a location remote from said database. The method and apparatus includes a server which collects biometric data on persons, a remote authentication terminal having a biometric sensing device and an access control device operable when the sensing device and the collected biometric data on a person match.

### CROSS-REFERENCE TO RELATED APPLICATIONS

This application is based on my Provisional Application No. 60/593,059, filed Dec. 6, 2004, and claims priority as to the common subject matter in the respective applications.

### FEDERALLY FUNDED RESEARCH

Not applicable.

### SEQUENCE LISTING, ETC. ON CD

Not applicable.

### BACKGROUND OF THE INVENTION

This invention generally relates to systems for permitting authorized persons to access a secure source and to operate the functions of a computer at such site. Stated differently, with the present invention, an authorized person may, for example, access secured buildings, make financial transactions, and the like, while preventing such access to an unauthorized person. To enhance the security of such a system, biometric data or information is utilized to properly identify an authorized person and permit only such persons to operate normally barred transactions, and otherwise gain access to a secure source site.

### DESCRIPTION OF RELATED ART

There are a number of systems available which generally provide access to secure sites via a computer network system. By way of example, using a password or card is one way of granting access to a computer to a person or persons who know such password. Unfortunately, passwords are frequently obtained by third persons who may use the same in a manner adverse to the authorized person. Other systems are time consuming, are not uniformly reliable, and possess shortcomings in their operation. There are also a number of biometric systems available, but these systems likewise have shortcomings which are overcome by the present invention.

### BRIEF SUMMARY OF THE INVENTION

The present invention is intended to overcome the deficiencies of prior art systems by using a biometric system to positively establish the identity of the person seeking access, by using the person's fingerprint, iris image, photographic likeness and/or other biometric parameters which are difficult, if not impossible, to duplicate.

A further feature of the invention is to minimize the communication channel traffic of a biometric authentication system.

It is another object or feature of the invention to minimize the inconvenience and obtrusiveness of biometric authentication systems.

The foregoing features are accomplished by utilizing a method and apparatus for biometric authentication systems comprising a server including a computer and one or more biometric data collection devices configured to collect biometric data from each authorized person. A main database stores collected biometric data. Several user lists in the server's memory identifies the persons who are authorized for the respective remote authentication terminals, and a communication channel for transferring the biometric data that only associates with the user lists from the server to each of respective remote authentication terminals.

The present invention further uses an apparatus and method for biometric authentication systems comprising one or more authentication terminals located at areas remote from the server, each such terminal including memory, a processor, a biometric information sensing device, one or several biometric data collection devices and other operational devices, and a communication channel for communication with the server. The processor is operative to compare biometric information data collected by the biometric information sensing device with biometric information stored in the memory and to determine the authenticity of the person seeking access.

Another aspect of the invention is a method comprising the steps of transferring authorized persons' biometric information to a specific remote authentication terminal. The server only transfers this information to the remote authentication terminal for the persons that are authorized for this terminal. The biometric information in the remote authentication terminal is a subset of main biometric information database in the server, and each database can exchange contents at any time. Each remote authentication terminal can hold different subsets of the main biometric information database. When the terminal needs more information in order to identify a person, it can ask the server to send more biometric information about this person to the terminal.

A further aspect of the invention is a method comprising the steps of transferring an unknown person's biometric information from a remote authentication terminal to the server for further identification. After a successful verification of a specific identity, a new person's biometric information can be collected from the biometric information sensing device to a remote authentication terminal, and then transferred to a server and added to the main database. Confirmation data includes instructions to the terminal to either keep this new biometric information or to discard the data, and will be sent to the remote authentication terminal. The unmatched biometric information can be added in to a separate database for further investigation or processing. The server also will keep a log of additional data entries.

A still further aspect of the invention is a method in which the remote authentication terminal maintains the most recent and most frequently authenticated person's information while keeping the local memory as small as possible in order to reduce the cost for each remote authentication terminal. During a communication channel or AC power outage, the remote authentication terminal will switch to standalone mode and continue to serve the person who has the authentication information already within the remote authentication terminal.

### BRIEF DESCRIPTION OF THE DRAWINGS

FIG. 1 is a block diagram of the architecture of a typical networked biometric identification system illustrating the preferred embodiment.

FIG. 2 illustrates the data structures for the system of the preferred embodiment.

FIG. 3 is a flow chart of the method and apparatus of the invention.

### DETAILED DESCRIPTION OF THE INVENTION

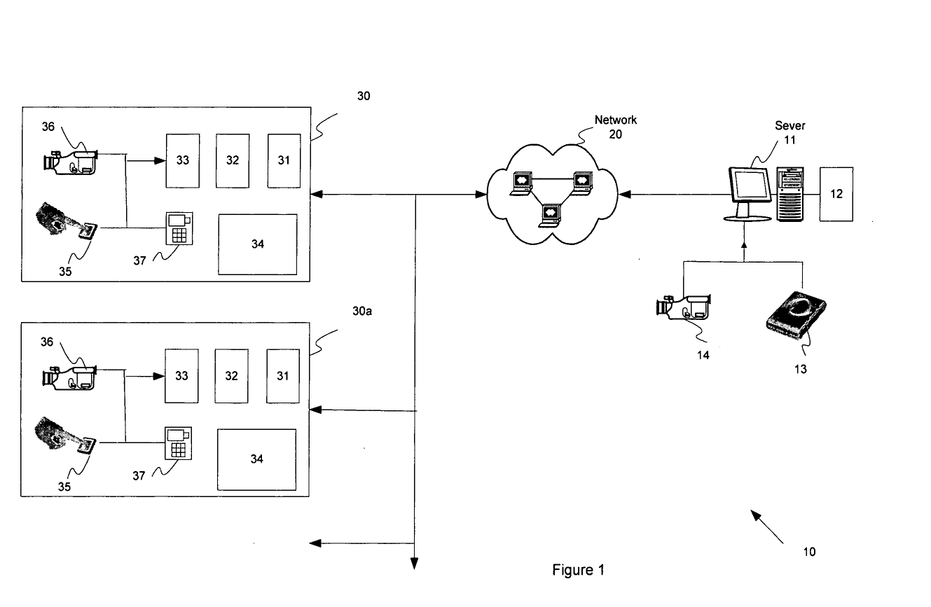

Referring to the drawing figures, FIG. 1 illustrates the system architecture of a preferred embodiment of the invention. The biometric access control system 10 includes a server 11, a plurality of remote authentication terminals 30, 30a, etc., and communications channel 20. Server 11 includes a computer, one or more biometric information sensing devices, such as a fingerprint scanner 13, a digital camera 14, and a communication channel interface. The remote authentication terminals each include a communication channel interface 31, memory 32, microprocessor 33, operational devices 34, such as an electrified lock, lights, or other devices, and plural biometric information sensing devices 35 and 26. The terminals may also include other input/output devices 37.

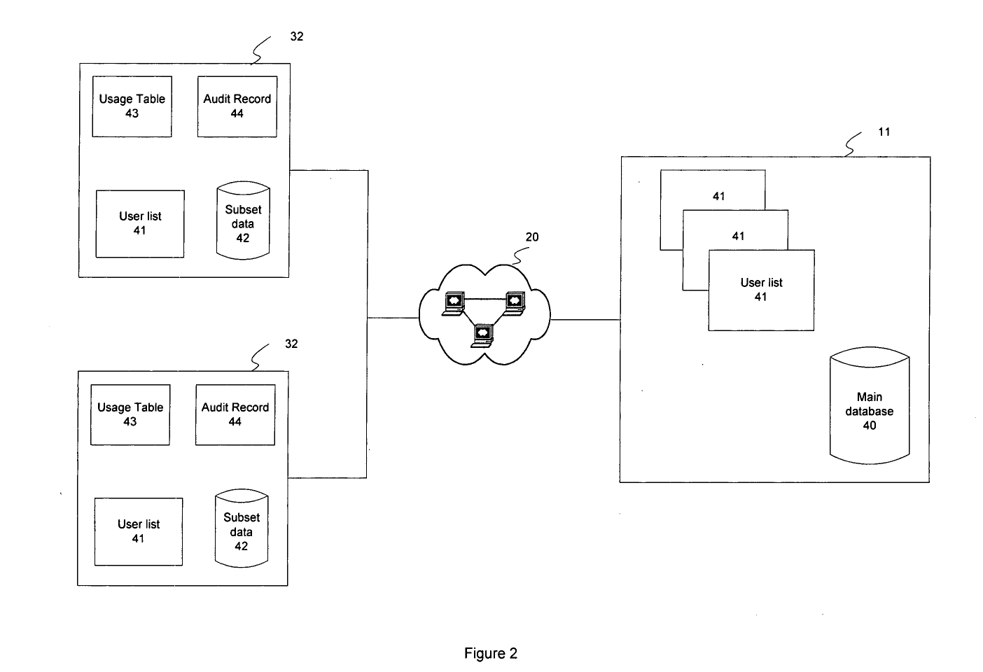

The server 11 is a computer, such as a mainframe computer, a personal computer, a minicomputer, a programmable logic controller, or any other device capable of accomplishing the processing and communication functions. Server 11 includes a central processing unit (CPU—not shown), a memory device 12 (such as a magnetic hard drive, random access memory (RAM), input/output devices (such as a keyboard and mouse, display, microphone, speaker, etc.), biometric information sensing device 13 and 14, a data bus (not shown) for providing communications between the various components and the appropriate interfaces for each component (also not shown). Biometric information sensing devices 13 or 14 serve to collect identification data during an enrollment procedure, as described below, and can be of any type, such as a fingerprint scanner, a camera for sensing facial information, a retinal scanner, or the like. Server 11 has a control program stored in memory device 12, which includes instructions and data structure (shown in FIG. 2) for accomplishing these functions.

Remote authentication terminal 30 is likewise a personal computer, a minicomputer, a programmable logic controller, or any other device capable of accomplishing the processing and communication functions. There are only two remote authentication terminals 30 and 30a shown in detail and discussed below, but any number of such terminals may be employed. However, each remote authentication terminal is similar, and thus the description below applies to each remote authentication terminal which may be added to the system.

Remote authentication terminal 30 includes microprocessor 33, a memory device 32 (such as a magnetic hard drive or random access memory (RAM), input/output devices 37 (such as a keyboard, keypad and mouse, display, microphone, speaker, etc.), biometric information sensing devices 35 and/or 36, and a data bus (not shown) for providing communications between the various components and the appropriate interfaces for each component, operational devices 34, such as an electrified lock, lights, or other devices. Biometric information sensing devices 35 or 36 serve to collect identification data during a verification procedure, as described below, and can be of any type for reading the data from a fingerprint scanner 13, a camera 14 for sensing facial information, a retinal scanner, or the like.

In the preferred embodiment, communications channel 20 is a local area network (LAN) such as an Ethernet network communication channel using cables, radio frequency transmission, fiber optical transmission, infrared transmission, or any other wired or wireless communication method. Any communications protocols and transmission medium can be used. For example, communication channel 20 can use TCP/IP protocol for Internet or Intranet. It also can be a removable recording medium, such as a diskette, tape or SmartChip.

The server 11 and its subsystems 12, 13, and 14 are typically located at a central location and provide a centralized source of authentication support for remote authentication terminals 30, 30a, etc., as well as collecting, storing and maintaining the authorized persons' biometric information.

The authentication terminals 30, etc., are typically located at locations remote from server 11, and provide fingerprint or other matching capabilities, and permits one-to-many searches or one-to-one verification searches in its own biometric database 42.

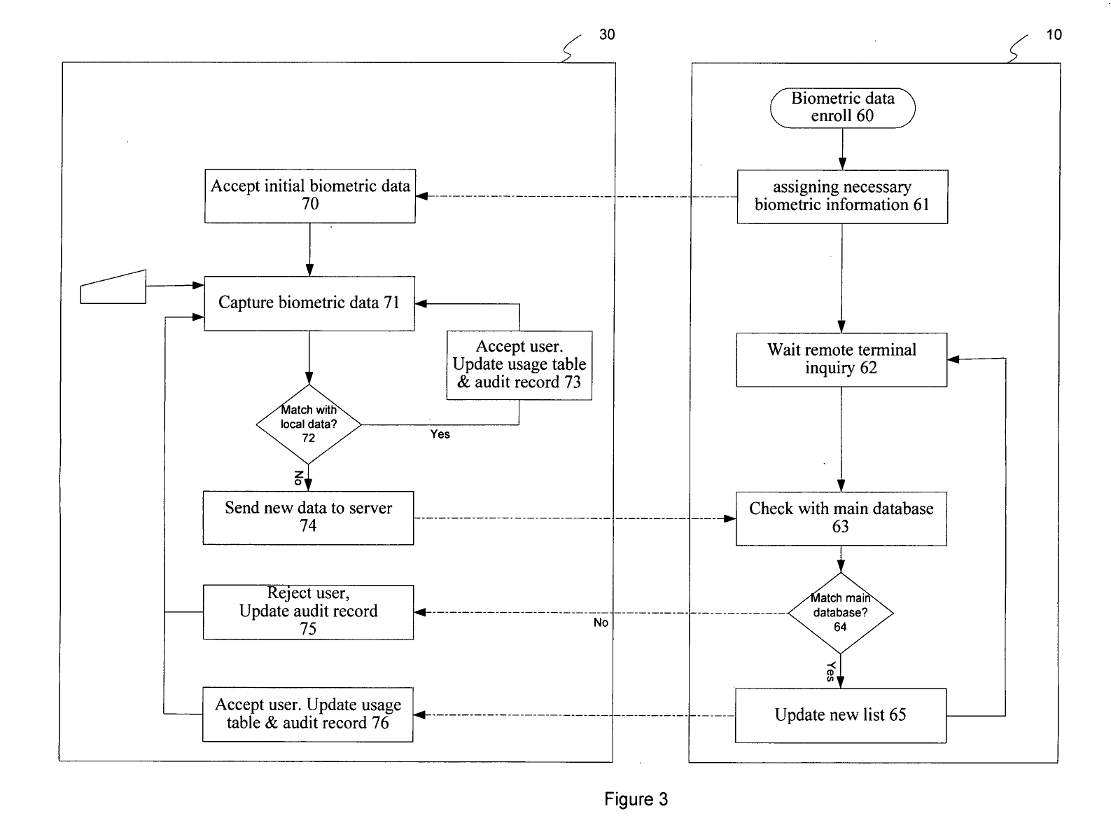

FIG. 3 illustrates the operation of the system 10. During the biometric data enrollment procedure 60, server 11 is collecting the authorized person's biometric information. The server 30 assigns necessary biometric information 61 to a remote authentication terminal 30 for only those persons that are authorized for that terminal. Once the remote authentication terminal 30 accepts the initial biometric data 70, the terminal is ready for authentication.

When the terminal captures biometric data 71 from a person seeking access, the terminal's microprocessor 33 will perform a match procedure 72 to compare the captured biometric data 71 with its own biometric database 42 in the memory 32. If they are matched, as at 73, the terminal will accept the user, and update usage table 43 as well as the audit record 44.

If the data does not match, the terminal will send the new captured biometric data 71 to the server 74 via its communication channel interface 31 and ask for a check with the main database 40 for further identification 63. If the server finds a match in its main database, confirmation data includes match success status and instructs the terminal to keep this authorized biometric information or discard the data, which will be sent to the update list in the remote authentication terminal 30, etc. The user list 41 for both sides will be updated as well. If the server finds no match in its main database, confirmation data including no match status, will be sent to the remote authentication terminal. The server also will keep a log for either a match or a no match occurrence.

In each event that the remote authentication terminal 30 loses communication with server 11, it will switch to a standalone mode and continue to work by its own local database 42. Since the local database 42 contains the most recent and most frequently authenticated person's information, the remote authentication terminal 30 can do the authentication for the majority of users who have been previously authorized to use this particular terminal. Once the communication channel is resumed, the local database 42 will be able to update with new data again.

During the AC power outage, the remote authentication terminal 30 will partially switch off the part of the device circuits not needed to maintain the basic functions, such as identification, authentication and access control, etc. to save the battery. For example, the communication channel 20 can be turned off. The remote authentication terminal 30 can switch to a standalone mode and continue to work.

1. An apparatus for authentication system comprising:
a server including a microprocessor, a memory, and a biometric information sensing device adapted to collect biometric information of an authorized person;
at least one remote authentication terminal, each including a microprocessor, a memory, a biometric information sensing device, and an access control device; and
a communication channel between said server and said remote authentication terminal.

2. An apparatus as recited in claim 1, wherein said server's memory contains a main database adapted to store biometric information assigned to authorized persons.

3. An apparatus as recited in claim 1, wherein said remote authentication terminal's memory contains a subset of said main database of biometric information assigned to authorized persons;

4. An apparatus as recited in claim 1, including a communication channel for exchanging the biometric information between said server and said remote authentication terminal.

5. A method of controlling and distributing biometric information comprising the steps of:
collecting biometric information assigned to an authorized person into a server's main database;
transferring biometric information from said main database to selected remote authentication terminals for only the persons authorized for each such selected terminal.

6. A method as recited in claim 5 in which the biometric information transferred to each remote authentication terminal is a subset of total biometric information for each person.

7. A method as recited in claim 5 in which a person utilizes a biometric sensing device at a remote terminal, and when the latter biometric information is a match with the collected data, access is provided to an otherwise secure site.

8. A method as recited in claim 5, when upon an unknown person's biometric information is collected from the biometric information sensing device, but said remote authentication terminal is unable to find a match in the subset biometric information database in the remote authentication terminal, the information will be transferred to the server for further identification.

9. A method as recited in claim 5, when an unknown person's biometric information is matched in the main database in the server, the biometric information can be added to said remote authentication terminal.

10. A method as recited in claim 5, when an unknown person's biometric information is not matched in the main database in the server, the biometric information can be added in to a separate database for further investigation or processing.

11. A method as set forth in claim 5, wherein upon a malfunction of said transfer of biometric information, said remote terminal will operate as a stand alone authentication system by utilizing such terminal's subset of biometric information.
